(19) United States
(12) Patent Application Publication
(10) Pub. No.: US 2026/0065524 A1
(43) Pub. Date: Mar. 5, 2026

(54) IMAGE GENERATION METHOD, ELECTRONIC DEVICE, AND STORAGE MEDIUM

(71) Applicant: Lenovo (Beijing) Limited, Beijing (CN)

(72) Inventors: Qihua XIAO, Beijing (CN); Zhijian MO, Beijing (CN)

(21) Appl. No.: 19/304,898

(22) Filed: Aug. 20, 2025

(30) Foreign Application Priority Data
Aug. 30, 2024 (CN) 202411215005.6

(51) Int. Cl. G06T 11/00; G06N 3/0455

(52) U.S. Cl. CPC G06T 11/00; G06N 3/0455

(57) ABSTRACT

An image generation method includes: obtaining input data and a target resolution for generating an image, the target resolution being configured to indicate a resolution of the image and being a first resolution or a second resolution; and determining a processing mode, according to the target resolution, for an image generation model, and processing the input data using the determined processing mode by the corresponding image generation model to obtain a generated image having the target resolution, wherein the first resolution and the second resolution are different and correspond to different processing modes for corresponding image generation models.

### CROSS-REFERENCE TO RELATED APPLICATION

This application claims priority to Chinese Patent Application No. 2024112150056, filed on Aug. 30, 2024, which is incorporated herein by reference in its entirety.

### FIELD OF THE TECHNOLOGY

The present disclosure relates to a field of image technology, and in particular to an image generation method and device.

### BACKGROUND

Some electronic devices are equipped with AI-based image generation models. These models may process input data and output a number of model-generated images. For example, based on an input image containing a cat, the model may generate another new image containing a cat.

Current image generation models are generally only capable of generating images of a particular resolution, such as, only 512*512 pixels or only 1024*1024 pixels, which cannot meet user's needs for generating images of different resolutions in different scenarios.

### SUMMARY

In one aspect, the present disclosure provides an image generation method. The method includes: obtaining input data and a target resolution for generating an image, the target resolution being configured to indicate a resolution of the image and being a first resolution or a second resolution; and determining a processing mode, according to the target resolution, for an image generation model, and processing the input data using the determined processing mode by the corresponding image generation model to obtain a generated image having the target resolution. The first resolution and the second resolution are different and correspond to different processing modes for corresponding image generation models.

In another aspect, the present disclosure provides an electronic device. The device includes: one or more processors and a memory storing computer program instructions that, when being executed, cause the one or more processors to perform: obtaining input data and a target resolution for generating an image, the target resolution being configured to indicate a resolution of the image and being a first resolution or a second resolution; and determining a processing mode, according to the target resolution, for an image generation model, and processing the input data using the determined processing mode by the corresponding image generation model to obtain a generated image having the target resolution. The first resolution and the second resolution are different and correspond to different processing modes for corresponding image generation models.

In another aspect, the present disclosure provides a non-transitory computer readable storage medium containing computer program instructions that, when being executed, cause at least one processor to perform: obtaining input data and a target resolution for generating an image, the target resolution being configured to indicate a resolution of the image and being a first resolution or a second resolution; and determining a processing mode, according to the target resolution, for an image generation model, and processing the input data using the determined processing mode by the corresponding image generation model to obtain a generated image having the target resolution. The first resolution and the second resolution are different and correspond to different processing modes for corresponding image generation models.

### BRIEF DESCRIPTION OF THE DRAWINGS

To more clearly illustrate the technical solutions in the embodiments of the present disclosure, the following briefly describes the figures used in the embodiments. The figures described below represent only certain embodiments of the present disclosure. Persons skilled in the technical field may, without inventive effort, derive other figures from the provided figures.

FIG. 1 is a flow chart of an image generation method provided in certain embodiments of the present disclosure.

FIG. 2 is a schematic diagram of a structure of an image generation model provided in certain embodiments of the present disclosure.

FIG. 3 is a schematic diagram of a method for generating images according to different processing modes provided in certain embodiments of the present disclosure.

FIG. 4 is a schematic diagram of a method for generating images according to different processing modes provided in certain embodiments of the present disclosure.

FIG. 5 is a schematic diagram of a method for generating images according to different processing modes provided in certain embodiments of the present disclosure.

FIG. 6 is a schematic diagram of a structure of an image generation device provided in certain embodiments of the present disclosure.

### DETAILED DESCRIPTION

The following provides a description of the technical solutions in certain embodiments of the present disclosure, in conjunction with the accompanying drawings. The described embodiments are only some of the embodiments of the present disclosure, and not necessarily all of them. Other embodiments derived by persons of ordinary skill in the technical field without inventive effort are within the scope of protection of the present disclosure.

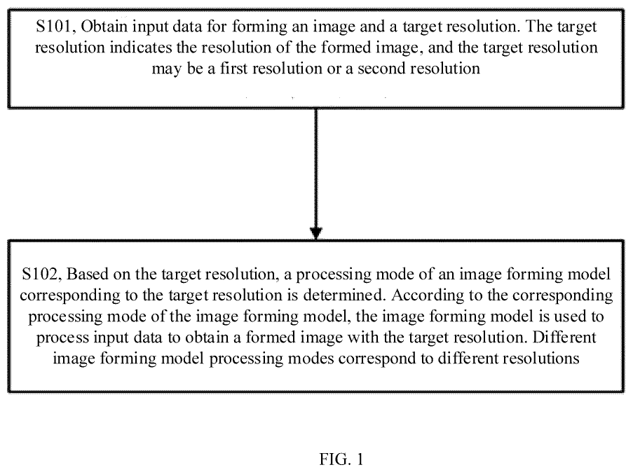

Embodiments of the present disclosure provide an image generation method. FIG. 1 illustrates a flow chart of an exemplary image generation method according to certain embodiments of the present disclosure. The method may include the following operations.

S101: Obtain input data for generating an image and a target resolution. The target resolution indicates the resolution of the generated image, and the target resolution may be a first resolution or a second resolution.

The input data for generating an image may include one or more frames of input image data. The input image data may include image data stored locally on the electronic device executing the image generation method, or may include image data obtained from a server. Based on user operations, the electronic device may determine one or more frames of image data from the locally stored image data and the server image data as the input image data.

The target resolution may be the resolution of the generated image. In S101, the electronic device may display two options corresponding to a first resolution and a second resolution, respectively. When the user selects the first resolution option, it is determined that an image with the first resolution is to be generated, and the target resolution is determined to be the first resolution. When the user selects the second resolution option, it is determined that an image with the second resolution is to be generated, and the target resolution is determined to be the second resolution.

For example, the first resolution may be 512*512 and the second resolution may be 1024*1024. Based on the user's selection, the device may determine the target resolution to be 512*512 or 1024*1024.

S102, based on the target resolution, a processing mode of an image generation model corresponding to the target resolution is determined. According to the corresponding processing mode of the image generation model, the image generation model is used to process input data to obtain a generated image with the target resolution. Different image generation model processing modes correspond to different resolutions.

In S102, when the target resolution is the first resolution, the device may process the input data according to the processing mode corresponding to the first resolution of the image generation model to obtain a generated image with the first resolution. When the target resolution is the second resolution, the device may process the input data according to the processing mode corresponding to the second resolution of the image generation model to obtain a generated image with the second resolution.

The image generation model may be pre-stored in the memory of an electronic device. When an image is to be generated, the electronic device loads the image generation model from the memory into a processor for running the model, thereby processing input data according to the image generation model.

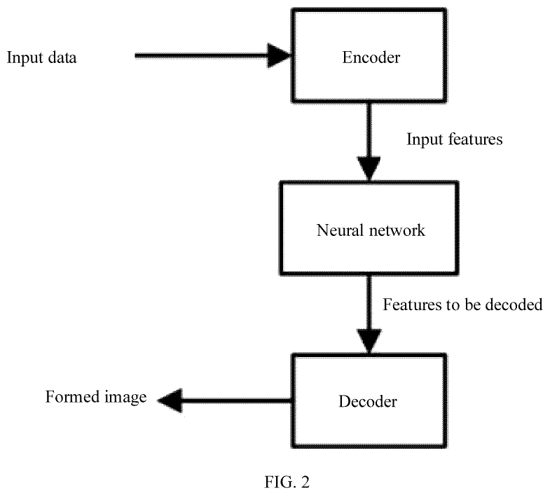

Referring to FIG. 2, an image generation model in certain embodiments may include at least one encoder, at least one neural network, and at least one decoder. The encoder may be a contrastive language-image pre-training (Clip) model based on contrastive learning, or other suitable model structures with encoding capabilities; the neural network may be a U-net structure, or other suitable neural network structures; and the decoder may be a variational auto-encoder (VAE) decoder, or other suitable decoders.

When processing input data according to the image generation model, the input data is first processed by the encoder to obtain corresponding input features. The input features are then processed by the neural network to obtain features to be decoded. Finally, the decoder processes the features to be decoded to obtain the generated image.

In certain embodiments, the processor used to run the model may include at least one of a central processing unit (CPU), a graphics processing unit (GPU), and an embedded neural network processor (NPU) of the electronic device.

In certain embodiments, when loading the image generation model, when the device has an NPU, the encoder, neural network, and decoder included in the image generation model may all be loaded into the NPU. Alternatively, the encoder may be loaded into the device's CPU, while the neural network and decoder may be loaded into the device's NPU.

Compared to loading the encoder into the NPU, loading the encoder into the CPU improves the efficiency of processing input data based on the encoder.

The beneficial effects of certain embodiments are as follows.

The image generation model may process input data according to different processing modes for different resolutions to obtain generated images of the first or second resolution, thereby meeting the requirements for obtaining images of different resolutions in different usage scenarios.

In certain embodiments, the image generation model may include at least two image generation models. For example, it may include a first image generation model corresponding to a first resolution and a second image generation model corresponding to a second resolution.

The first image generation model may include a first neural network and a first decoder for generating images at the first resolution, and the second image generation model may include a second neural network and a second decoder for generating images at the second resolution.

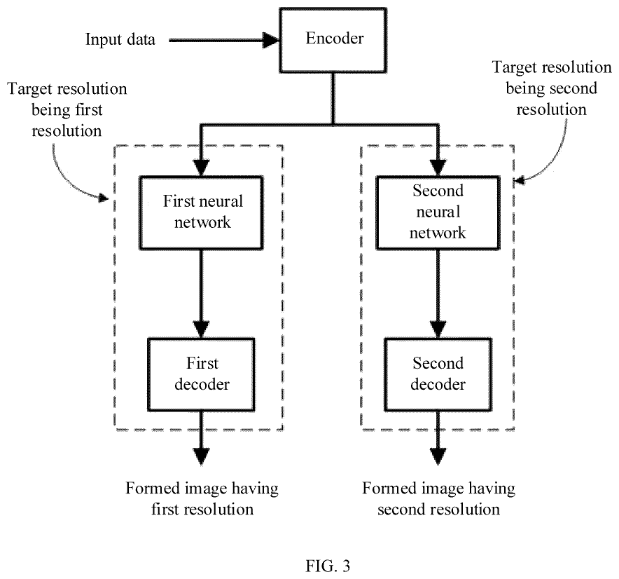

Referring to FIG. 3, based on the processing mode of the corresponding image generation model, the image generation model may be used to process input data to obtain a generated image at the target resolution.

Determining a target image generation model corresponding to the target resolution, where the target image generation model is either the first image generation model or the second image generation model;

Processing the input data using the neural network and decoder of the target image generation model to obtain a generated image at the target resolution.

That is, when the target resolution is the first resolution, the target image generation model determined by the device may include a first neural network and a first decoder. The device may process input data based on the first neural network and the first decoder to obtain a generated image with the first resolution.

When the target resolution is the second resolution, the target image generation model determined by the device may include a second neural network and a second decoder. The device may process input data based on the second neural network and the second decoder to obtain a generated image with the second resolution.

In certain embodiments, the first neural network and the first decoder, and the second neural network and the second decoder may all be stored in the device's memory. When the target image generation model is determined to be the first image generation model, the device loads the first neural network and the first decoder into a corresponding processor to obtain a generated image with the first resolution based on the first image generation model. When the target image generation model is determined to be the second image generation model, the device loads the second neural network and the second decoder into a corresponding processor to obtain a generated image with the second resolution based on the second image generation model.

In certain embodiments, the first and second image generation models may share a common encoder. As shown in FIG. 3, the device may process input data using the encoder to obtain corresponding input features. When the target resolution is the first resolution, the input features are input to the first neural network, which is then processed sequentially by the first neural network and the first decoder to produce a generated image with the first resolution. When the target resolution is the second resolution, the input features are input to the second neural network, which is then processed by the second neural network and the second decoder to produce a generated image with the second resolution.

The advantage of sharing the encoder is that the device store only one encoder when storing the first and second image generation models, saving device storage space.

In certain embodiments, the image generation model may include a target neural network and a target decoder.

The target neural network may be a first neural network corresponding to the first resolution, used to generate images at the first resolution, or a second neural network corresponding to the second resolution, used to generate images at the second resolution.

The target decoder may include one or more decoders.

According to the processing mode of the corresponding image generation model, the method for processing the input data using the image generation model to obtain a generated image with the target resolution may be:
In the processing mode corresponding to the target resolution, the input data is processed according to the target neural network to obtain target features to be decoded corresponding to the target resolution. Different processing modes have different processing flows for processing the input data according to the target neural network;
The target features to be decoded are processed according to the target decoder to obtain a generated image with the target resolution.

In certain embodiments, the target neural network may correspond to different processing flows in the processing modes corresponding to different resolutions. That is, when the target resolution is a first resolution, the device may process the input data according to the target neural network according to the processing flow corresponding to the first resolution to obtain target features to be decoded corresponding to the first resolution, and then use the target decoder to process the target features to be decoded at the first resolution to obtain a generated image with the first resolution. When the target resolution is a second resolution, the device may process the input data according to the target neural network according to the processing flow corresponding to the second resolution to obtain target features to be decoded corresponding to the second resolution, and then use the target decoder to process the target features to be decoded at the second resolution to obtain a generated image with the second resolution.

The beneficial effect of certain embodiments is that the device may obtain generated images of different resolutions through different processing flows, utilizing only the target neural network. Consequently, the device's memory may only need to store a single target neural network to meet the needs of generating images at two or more or multiple resolutions, eliminating the need to having to store two or more or multiple neural networks corresponding to each resolution, thereby conserving device storage space.

In certain embodiments, the target neural network may be a second neural network corresponding to the second resolution, and the first resolution may be smaller than the second resolution. For example, the first resolution may be 512*512, and the second resolution may be 1024*1024.

In a processing mode corresponding to the target resolution, processing input data according to the target neural network to obtain target features to be decoded corresponding to the target resolution may include:
When the target resolution is the first resolution, processing the input data according to the target neural network to obtain features to be decoded corresponding to the second resolution, and adjusting the resolution of the features to be decoded to obtain target features to be decoded corresponding to the first resolution;
When the target resolution is the second resolution, the input data is processed according to the target neural network to obtain features to be decoded corresponding to the second resolution, and the features to be decoded serve as the target features to be decoded.

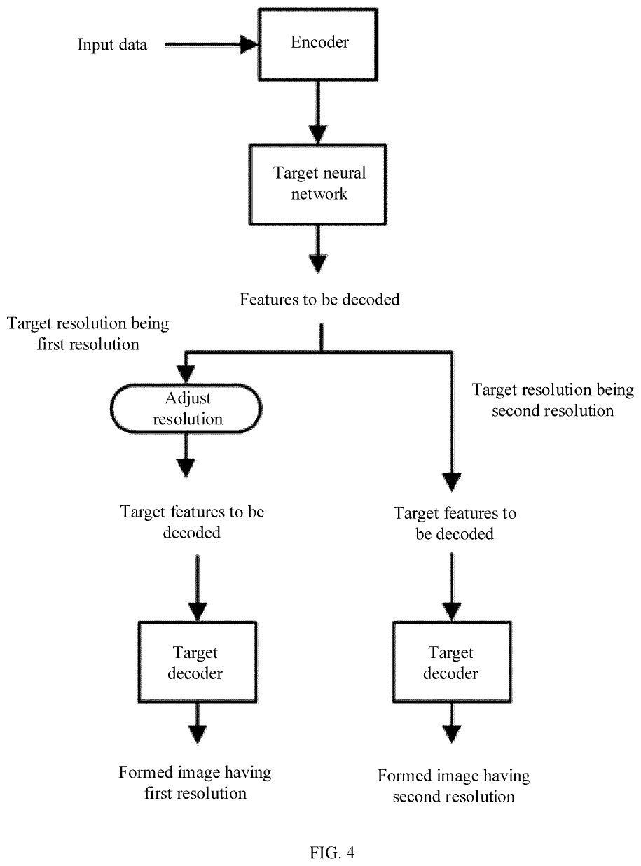

As shown in FIG. 4, when the target neural network is the second neural network and the target resolution is the first resolution, the processing flow for processing the input data according to the target neural network may be:

Processing the input data with the encoder to obtain input features; processing the input features with the second neural network to obtain features to be decoded corresponding to the second resolution as output by the second neural network; then adjusting the resolution of the features to be decoded to convert the features to be decoded corresponding to the second resolution into target features to be decoded corresponding to the first resolution.

When the target resolution is the second resolution, the processing flow for processing the input data according to the target neural network may be:

Processing the input data with the encoder to obtain input features; processing the input features with the second neural network to obtain features to be decoded corresponding to the second resolution as output by the second neural network; and determining the features to be decoded output by the second neural network as the target features to be decoded.

In certain embodiments, the device may implement different processing flows by configuring different conversion parameters corresponding to different resolutions.

In certain embodiments, the image generation model may include a conversion matrix, denoted as matrix D, located between the target neural network and the target decoder. The parameters contained in matrix D are called conversion parameters. After obtaining the to-be-decoded features output by the target neural network, the to-be-decoded features may be processed using matrix D, with the resulting results serving as target to-be-decoded features. This processing may be expressed as C*D=E, where C represents the to-be-decoded features output by the target neural network, and E represents the target to-be-decoded features obtained after processing.

When the target resolution is a first resolution, the device may configure the conversion parameters of matrix D to first conversion parameters that enable resolution adjustment. This allows matrix D to process to-be-decoded features corresponding to the second resolution into target to-be-decoded features corresponding to the first resolution.

When the target resolution is a second resolution, the device may configure the conversion parameters of matrix D to second conversion parameters that ensure that the data C and E before and after processing are identical. In this way, processing the to-be-decoded features using matrix D is equivalent to directly determining the to-be-decoded features as the target to-be-decoded features.

The format of matrix D and the values of the first and second conversion parameters may be set based on actual circumstances and are not limited.

For example, when the first resolution is 512*512 and the second resolution is 1024*1024, matrix D may be a 1024*1024 matrix. As shown in the formula below, the conversion parameters contained in matrix D may be four block matrices D1 through D4, each of which is a 512*512 matrix.

$$D = [ \begin{matrix}D 1 & D 2 \\ D 3 & D 4\end{matrix} ]$$

When the target resolution is the second resolution, the second conversion parameters configured for the device may be that the four block matrices D1 through D4 are all identity matrices, meaning that all diagonal elements of each block matrix are equal to 1 and all off-diagonal elements are equal to 0.

When the target resolution is the first resolution, the first conversion parameters configured for the device may be that at least one of the four block matrices D1 through D4 is not the identity matrix.

In certain embodiments, the target neural network may be a first neural network corresponding to the first resolution. Processing the input data according to the target neural network in the processing mode corresponding to the target resolution to obtain target features to be decoded corresponding to the target resolution may include:
When the target resolution is the first resolution, processing the input data according to the target neural network to obtain features to be decoded corresponding to the first resolution, using the features to be decoded as the target features to be decoded;
When the target resolution is the second resolution, processing the input data according to the target neural network two or more or multiple times to obtain two or more or multiple features to be decoded corresponding to the first resolution; and obtaining target features to be decoded corresponding to the second resolution composed of the two or more or multiple features to be decoded.

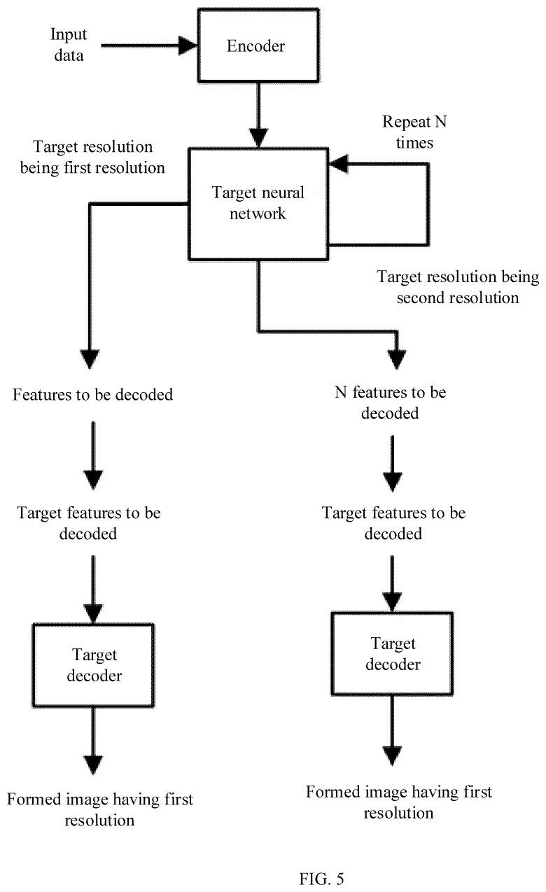

See FIG. 5. When the target resolution is the first resolution, the input features processed by the encoder may be input to the first neural network, processed by the first neural network to obtain features to be decoded corresponding to the first resolution, and then input as target features to be decoded to the target decoder. The target decoder processes the target features to obtain an image at the first resolution.

When the target resolution is the second resolution, the input features processed by the encoder may be input into the first neural network. The first neural network may be run N times to process the input features, obtaining N to-be-decoded features corresponding to the first resolution. These N to-be-decoded features are combined into target to-be-decoded features corresponding to the second resolution. The target to-be-decoded features are processed by the target decoder to obtain an image at the second resolution.

In certain embodiments, when the target resolution is the second resolution, the N to-be-decoded features may be directly input into the decoder sequentially, or the N to-be-decoded features may be concatenated or spliced into a single feature in a particular manner, and the concatenated or spliced feature is input into the decoder as the target to-be-decoded feature.

N may be determined based on the ratio between the first resolution and the second resolution. For example, when the first resolution is 512*512 and the second resolution is 1024*1024, the data volume of the second resolution image is four times that of the first resolution image, so N may be set to 4.

In certain embodiments, to implement the scheme of running the target neural network two or more or multiple times, the processor in the electronic device used to run the target neural network and the target decoder may be split into two processing units. The target neural network and the target decoder may then be loaded into each of the two processing units, so that the processing unit that loads the target neural network may run the target neural network two or more or multiple times.

In certain embodiments, when an electronic device runs a target neural network and a target decoder using an embedded neural network processor (NPU), the NPU may be divided into a first processing unit and a second processing unit. The target neural network is loaded into the first processing unit of the electronic device's embedded neural network processor, and the target decoder is loaded into the second processing unit of the embedded neural network processor. The first and second processing units are different. Thus, the first processing unit may be used to run the target neural network two or more or multiple times when the target resolution is the second resolution.

In certain embodiments, depending on the target resolution, the target decoder may be either the first decoder or the second decoder. For example, when the target resolution is the first resolution, the target decoder is the first decoder corresponding to the first resolution; when the target resolution is the second resolution, the target decoder is the second decoder corresponding to the second resolution.

The first decoder is configured to process input features to be decoded (or target features to be decoded) corresponding to the first resolution and output a generated image at the first resolution.

The second decoder is configured to process input features to be decoded (or target features to be decoded) corresponding to the second resolution and output a generated image at the second resolution.

In this case, the device's memory may simultaneously store a first decoder and a second decoder. When the target resolution is determined to be the first resolution, the device determines the first decoder as the target decoder. When the target resolution is determined to be the second resolution, the device determines the second decoder as the target decoder. The target decoder is then loaded into the corresponding processor, whereupon the first or second decoder processes the features to be decoded (or the target features to be decoded) to obtain an output image of the corresponding resolution.

The advantage of using different decoders for different target resolutions is that generating images according to the target decoder corresponding to the target resolution improves the quality of the resulting image and alleviates issues such as low clarity and excessive noise that may exist in the generated image.

In certain embodiments, the input data may include input image data, and may also include input image data and input text data.

Correspondingly, the encoder of the image generation model may include an image encoder and a text encoder.

The text encoder is configured to process the input text data to obtain input text features.

The image encoder is configured to process the input image data to obtain input image features.

Input features consist of input image features and input text features.

The input text data may be used to describe the content to be included in the generated image. For example, the input text data may include “draw a dog in the input image” or “add a house to the image.”

The text encoder may extract text features of the content indicated in the input text data as input text features. For example, the input text features may include the text features of “dog” and the text features of “house” in the example above.

Thus, the neural network can, based on the input text features, add the image features of the corresponding content to the output features to be decoded, so that after the decoder decodes the features to be decoded, it may obtain a generated image containing the corresponding content.

Based on the above example, the neural network can, based on the text features of “dog,” add the image features of “dog” to the features to be decoded, and based on the text features of “house,” add the image features of “house” to the features to be decoded. The decoder may decode the features to be decoded containing the image features of “dog” to obtain a generated image containing a dog, and the decoder may decode the features to be decoded containing the image features of “house” to obtain a generated image containing a house.

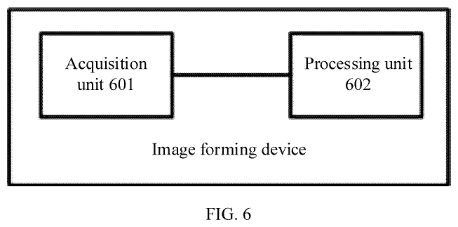

The present embodiment also provides an image generation device, as shown in FIG. 6. The device may include the following units:

An acquisition unit 601 is configured to obtain input data and a target resolution for generating an image. The target resolution indicates the resolution of the generated image, and the target resolution may be a first resolution or a second resolution.

A processing unit 602 is configured to, based on the target resolution, determine a processing mode of an image generation model corresponding to the target resolution. Based on the processing mode of the corresponding image generation model, the image generation model is used to process the input data to obtain a generated image having the target resolution. The image generation model processing modes differ for different resolutions.

In certain embodiments, the image generation model includes a first image generation model corresponding to the first resolution and a second image generation model corresponding to the second resolution. The first image generation model includes a first neural network and a first decoder, and the second image generation model includes a second neural network and a second decoder.

When processing the input data using the image generation model to obtain a generated image having the target resolution, based on the processing mode of the corresponding image generation model, the processing unit 602 may be configured to:

Determine a target image generation model corresponding to the target resolution, where the target image generation model is either a first image generation model or a second image generation model;
Process input data according to the neural network and decoder of the target image generation model to obtain a generated image having the target resolution.

In certain embodiments, the image generation model includes a target neural network and a target decoder, where the target neural network is either a first neural network corresponding to the first resolution or a second neural network corresponding to the second resolution.

When processing the input data using the image generation model according to the processing mode of the corresponding image generation model to obtain a generated image having the target resolution, the processing unit 602 may be configured to:
In the processing mode corresponding to the target resolution, process the input data according to the target neural network to obtain target features to be decoded corresponding to the target resolution. Different processing modes have different processing flows for processing the input data according to the target neural network;
Process the target features to be decoded according to the target decoder to obtain a generated image having the target resolution.

In certain embodiments, the target neural network is a second neural network corresponding to the second resolution, and the first resolution is smaller than the second resolution.

When processing unit 602 processes input data according to the target neural network in a processing mode corresponding to the target resolution to obtain target features to be decoded corresponding to the target resolution, the processing unit 602 may be configured to:
When the target resolution is the first resolution, process the input data according to the target neural network to obtain features to be decoded corresponding to the second resolution, and adjust the resolution of the features to be decoded to obtain target features to be decoded corresponding to the first resolution;
When the target resolution is the second resolution, process the input data according to the target neural network to obtain features to be decoded corresponding to the second resolution, and use the features to be decoded as the target features to be decoded.

In certain embodiments, the target neural network is the first neural network corresponding to the first resolution, and the first resolution is smaller than the second resolution.

When processing unit 602 processes input data according to a target neural network in a processing mode corresponding to a target resolution to obtain target features to be decoded corresponding to the target resolution, the processing unit 602 may be configured to:
When the target resolution is a first resolution, process the input data according to the target neural network to obtain features to be decoded corresponding to the first resolution, with the features to be decoded serving as target features to be decoded;
When the target resolution is a second resolution, process the input data according to the target neural network two or more or multiple times to obtain two or more or multiple features to be decoded corresponding to the first resolution; and obtain a target feature to be decoded corresponding to the second resolution composed of the two or more or multiple features to be decoded.

In certain embodiments, the target neural network is loaded into a first processing unit 602 of an embedded neural network processor of an electronic device, and the target decoder is loaded into a second processing unit 602 of the embedded neural network processor, where the first processing unit 602 and the second processing unit 602 are different.

The first processing unit 602 is configured to execute the target neural network two or more or multiple times when the target resolution is the second resolution.

In certain embodiments, when the target resolution is the first resolution, the target decoder is a first decoder corresponding to the first resolution.

When the target resolution is the second resolution, the target decoder is a second decoder corresponding to the second resolution.

In certain embodiments, the image processing model further includes an encoder, which processes input data to obtain input features, and the input features are used to input the target neural network.

The encoder is loaded into the central processing unit of the electronic device.

In certain embodiments, the input data includes input image data and input text data.

The encoder includes an image encoder and a text encoder.

The text encoder processes the input text data to obtain input text features.

The image encoder processes the input image data to obtain input image features.

The input image features and the input text features constitute the input features.

The operating particulars of the image generation device of certain embodiments may be found in the relevant steps of the image generation method and the description of which is not repeated here for brevity.

Certain embodiments are described, with each embodiment focusing on its differences from other embodiments. Similar or identical parts between the various embodiments may be referenced separately.

For ease of description, the above systems or devices are described separately by function, divided into various modules or units. The functions of each unit may be implemented in the same or different software and/or hardware components.

Those skilled in the technical field understand that certain embodiments of the present disclosure may be implemented using software plus the necessary general-purpose hardware platform. The technical solution may be embodied in the form of a software product. This computer software product may be stored in a storage medium, such as ROM/RAM, a magnetic disk, or an optical disk, and includes instructions for enabling a computer device (which may be a personal computer, server, or network device, or the like) to execute the methods described.

In certain embodiments, relational terms such as first, second, third, and fourth are used solely to distinguish one entity or operation from another, and do not necessarily require or imply any relationship or order between these entities or operations. Furthermore, the terms “comprise,” “include,” or any other variations thereof are intended to encompass non-exclusive inclusion, such that a process, method, article, device, or apparatus including a list of elements includes not only those elements but also other elements not expressly listed, or elements inherent to such process, method, article, device, or apparatus. Without further limitation, the phrase “comprising a . . . ” does not preclude the presence of additional identical elements in the process, method, article, device, or apparatus comprising the recited elements.

Certain embodiments of the present disclosure are described. Suitable improvements and modifications may be readily made by those skilled in the technical field without departing from the principles of the present disclosure, and such improvements and modifications are within the scope of protection of the present disclosure.

What is claimed is:

1. An image generation method, comprising:
obtaining input data and a target resolution for generating an image, the target resolution being configured to indicate a resolution of the image and being a first resolution or a second resolution; and
determining a processing mode, according to the target resolution, for an image generation model, and processing the input data using the determined processing mode by the corresponding image generation model to obtain a generated image having the target resolution, wherein the first resolution and the second resolution are different and correspond to different processing modes for corresponding image generation models.

2. The method of claim 1, wherein the image generation model includes a first image generation model corresponding to the first resolution and a second image generation model corresponding to the second resolution, the first image generation model including a first neural network and a first decoder, and the second image generation model including a second neural network and a second decoder;
processing the input data using the image generation model according to the processing mode of the corresponding image generation model to obtain the generated image having the target resolution includes:
determining a target image generation model corresponding to the target resolution, the target image generation model being either the first image generation model or the second image generation model;
processing the input data using the neural network and decoder of the target image generation model to obtain the generated image having the target resolution.

3. The method of claim 1, wherein the image generation model includes a target neural network and a target decoder, the target neural network being a first neural network corresponding to the first resolution or a second neural network corresponding to the second resolution;
processing the input data using the image generation model according to the processing mode of the corresponding image generation model to obtain the generated image having the target resolution includes:
in the processing mode corresponding to the target resolution, processing the input data using the target neural network to obtain target features to be decoded corresponding to the target resolution, wherein different processing modes involve different processing flows for processing the input data using the target neural network;
processing the target features to be decoded using the target decoder to obtain the generated image having the target resolution.

4. The method of claim 3, wherein the target neural network is the second neural network corresponding to the second resolution, and the first resolution is smaller than the second resolution;
in the processing mode corresponding to the target resolution, processing the input data according to the target neural network to obtain target features to be decoded corresponding to the target resolution includes:
when the target resolution is the first resolution, processing the input data according to the target neural network to obtain features to be decoded corresponding to the second resolution, and adjusting a resolution of the features to be decoded to obtain target features to be decoded corresponding to the first resolution;
when the target resolution is the second resolution, processing the input data according to the target neural network to obtain features to be decoded corresponding to the second resolution, and using the features to be decoded as the target features to be decoded.

5. The method of claim 3, wherein the target neural network is the first neural network corresponding to the first resolution, the first resolution being smaller than the second resolution;
processing the input data according to the target neural network in the processing mode corresponding to the target resolution to obtain target features to be decoded corresponding to the target resolution includes:
when the target resolution is the first resolution, processing the input data according to the target neural network to obtain features to be decoded corresponding to the first resolution, using the features to be decoded as the target features to be decoded;
when the target resolution is the second resolution, processing the input data according to the target neural network multiple times to obtain multiple features to be decoded corresponding to the first resolution; and
obtaining a target feature to be decoded corresponding to the second resolution and including the multiple features to be decoded.

6. The method of claim 5, wherein the target neural network is loaded into a first processing unit of an embedded neural network processor of the electronic device, and the target decoder is loaded into a second processing unit of the embedded neural network processor, wherein the first processing unit and the second processing unit are different;
the first processing unit is configured to run the target neural network multiple times when the target resolution is the second resolution.

7. The method of claim 3, wherein when the target resolution is the first resolution, the target decoder is a first decoder corresponding to the first resolution; and when the target resolution is the second resolution, the target decoder is a second decoder corresponding to the second resolution.

8. The method of claim 3, wherein the image processing model includes an encoder configured to process input data to obtain input features, which are input into the target neural network;
the encoder is loaded into a central processing unit of the electronic device.

9. The method of claim 8, wherein the input data includes input image data and input text data;
the encoder includes an image encoder and a text encoder;
the text encoder is configured to process the input text data to obtain input text features;
the image encoder is configured to process the input image data to obtain input image features; and
the input image features and the input text features constitute the input features.

10. An electronic device comprising: one or more processors and a memory storing computer program instructions that, when being executed, cause the one or more processors to perform:
obtaining input data and a target resolution for generating an image, the target resolution being configured to indicate a resolution of the image and being a first resolution or a second resolution; and
determining a processing mode, according to the target resolution, for an image generation model, and processing the input data using the determined processing mode by the corresponding image generation model to obtain a generated image having the target resolution, wherein the first resolution and the second resolution are different and correspond to different processing modes for corresponding image generation models.

11. The electronic device of claim 10, wherein the image generation model includes a first image generation model corresponding to the first resolution and a second image generation model corresponding to the second resolution, the first image generation model including a first neural network and a first decoder, and the second image generation model including a second neural network and a second decoder; and
the one or more processors are further configured to perform:
determining a target image generation model corresponding to the target resolution, the target image generation model being either the first image generation model or the second image generation model;
processing the input data using the neural network and decoder of the target image generation model to obtain the generated image having the target resolution.

12. The electronic device of claim 10, wherein the image generation model includes a target neural network and a target decoder, the target neural network being a first neural network corresponding to the first resolution or a second neural network corresponding to the second resolution; and
the one or more processors are further configured to perform:
in the processing mode corresponding to the target resolution, processing the input data using the target neural network to obtain target features to be decoded corresponding to the target resolution, wherein different processing modes involve different processing flows for processing the input data using the target neural network;
processing the target features to be decoded using the target decoder to obtain the generated image having the target resolution.

13. The electronic device of claim 12, wherein the target neural network is the second neural network corresponding to the second resolution, and the first resolution is smaller than the second resolution; and
the one or more processors are further configured to perform:
when the target resolution is the first resolution, processing the input data according to the target neural network to obtain features to be decoded corresponding to the second resolution, and adjusting a resolution of the features to be decoded to obtain target features to be decoded corresponding to the first resolution;
when the target resolution is the second resolution, processing the input data according to the target neural network to obtain features to be decoded corresponding to the second resolution, and using the features to be decoded as the target features to be decoded.

14. The electronic device of claim 12, wherein the target neural network is the first neural network corresponding to the first resolution, the first resolution being smaller than the second resolution; and
the one or more processors are further configured to perform:
when the target resolution is the first resolution, processing the input data according to the target neural network to obtain features to be decoded corresponding to the first resolution, using the features to be decoded as the target features to be decoded;
when the target resolution is the second resolution, processing the input data according to the target neural network multiple times to obtain multiple features to be decoded corresponding to the first resolution; and
obtaining a target feature to be decoded corresponding to the second resolution and including the multiple features to be decoded.

15. The electronic device of claim 14, wherein the target neural network is loaded into a first processing unit of an embedded neural network processor of the electronic device, and the target decoder is loaded into a second processing unit of the embedded neural network processor, wherein the first processing unit and the second processing unit are different;
the first processing unit is configured to run the target neural network multiple times when the target resolution is the second resolution.

16. The electronic device of claim 12, wherein when the target resolution is the first resolution, the target decoder is a first decoder corresponding to the first resolution; and when the target resolution is the second resolution, the target decoder is a second decoder corresponding to the second resolution.

17. The electronic device of claim 12, wherein the image processing model includes an encoder configured to process input data to obtain input features, which are input into the target neural network;
the encoder is loaded into a central processing unit of the electronic device.

18. The electronic device of claim 17, wherein the input data includes input image data and input text data;
the encoder includes an image encoder and a text encoder;
the text encoder is configured to process the input text data to obtain input text features;
the image encoder is configured to process the input image data to obtain input image features; and
the input image features and the input text features constitute the input features.

19. The electronic device of claim 10, wherein the image generation model includes a first image generation model and a second image generation model, the first image generation model includes a first neural network and a first decoder, and the second image generation model includes a second neural network and a second decoder, the second neural network differs from the first neural network, and the second decoder differs from the first decoder.

20. A non-transitory computer readable storage medium containing computer program instructions that, when being executed, cause at least one processor to perform:
obtaining input data and a target resolution for generating an image, the target resolution being configured to indicate a resolution of the image and being a first resolution or a second resolution; and
determining a processing mode, according to the target resolution, for an image generation model, and processing the input data using the determined processing mode by the corresponding image generation model to obtain a generated image having the target resolution, wherein the first resolution and the second resolution are different and correspond to different processing modes for corresponding image generation models.
